(19) United States
(12) Patent Application Publication
(10) Pub. No.: US 2009/0077906 A1
(43) Pub. Date: Mar. 26, 2009

(54) LOADING DOCK TRUCK SHELTERS

(75) Inventors: Joseph J. Tramonte, JR., Wauwatosa, WI (US); Ralph W. Moody, New Berlin, WI (US)

Correspondence Address: PERKINS COIE LLP;PATENT-SEA, P.O. BOX 1247, SEATTLE, WA, 98111-1247, US

(73) Assignee: 4Front Engineered Solutions, Inc., Carrollton, TX (US)

(21) Appl. No.: 11/860,468

(22) Filed: Sep. 24, 2007

(51) Int. Cl. B65G 69/28; E04F 10/02; E04H 14/00

(52) U.S. Cl. 52/173.2; 160/56

(57) ABSTRACT

Trailer shelters having foam head and side members are described herein. An over road trailer shelter configured in accordance with one embodiment includes a flexible head curtain configured to extend horizontally along a top portion of an opening in a warehouse or other building. The flexible head curtain can include at least one fabric flap hingeably attached to an exterior surface of a base fabric layer. The fabric flap is configured to protect the head member from damage resulting from repeated trailer contact. A trailer enclosure configured in accordance with another embodiment includes a head member that extends horizontally between first and second side members. Each of the side members and the head member includes a compressible foam portion covered by a fabric portion. In addition, each of the side members supports a flexible side curtain that extends inwardly to seal against the sides of the trailer.

### TECHNICAL FIELD

The present disclosure relates generally to enclosures that provide shelter and/or a seal between a shipping trailer and a loading dock.

### BACKGROUND

Warehouses typically include one or more loading docks for transferring goods to and from over road trailers. Conventional loading docks usually consist of an opening in a side of the warehouse. The opening is typically covered by a roll up door, and is usually positioned a few feet above the ground to be approximately level with shipping trailers. To load or unload goods, the doors on the aft end of the trailer are opened and the trailer is backed up to the loading dock opening. Workers can then pass into the trailer through the opening to load or unload goods.

There are various types of loading dock enclosures that are used for sheltering and/or sealing the open end of the trailer during the loading and unloading process. Such shelters are described in, for example, U.S. Pat. Nos. 4,213,279; 4,601,142; 4,711,059; 4,718,207; 4,799,342; 4,885,881; 5,282,384; 5,953,868; and 6,311,435; U.S. Patent Publication Nos.: 2003/0177720; and 2004/0134139; and International Patent Publication No. WO 2006/052661. Each of the aforementioned patents and patent applications are incorporated into the present disclosure in their entirety by reference.

One shortcoming associated with conventional trailer shelters is that they are typically manufactured from wood, steel, fiberglass, and other similar materials. As a result, the shelter can sustain serious damage if impacted by a misaligned trailer. To overcome this problem, some prior art shelters are made from foam to absorb the impact from a misaligned trailer. These foam shelters, however, often fail to provide a sufficient seal around the trailer.

Another downside of conventional trailer shelters is that if a trailer is slightly misaligned with a loading dock opening, the shelter may not seal properly or provide sufficient protection from the elements. Although some prior art shelters have flexible side flaps to overcome this problem, the flap members can sustain significant wear and degradation after only moderate use. As a result, the shelter may require relatively frequent repair or replacement.

### SUMMARY

The following summary is provided for the benefit of the reader only, and is not intended to limit the invention as set forth by the claims in any way.

The present disclosure is directed generally to over road trailer enclosures for use with loading docks on warehouses and other buildings. An over road trailer shelter configured in accordance with one aspect of the invention includes a flexible head curtain that extends horizontally along a top portion of an opening in a warehouse or other building. The flexible head curtain includes at least one fabric flap hingeably attached to an exterior surface of a base fabric layer. The fabric flap protects the base fabric layer of the flexible head curtain from damage from repeated contact with over road trailers.

A trailer enclosure configured in accordance with another aspect of the invention includes a first side member that extends vertically along a first side portion of a loading dock door opening, and a second side member that extends vertically along a second side portion of the door opening. The enclosure further includes a head member that extends horizontally between the first and second side members adjacent to an upper portion of the door opening. The head member and the first and second side members each include a compressible foam portion covered by an exterior fabric portion. Together, the first side member, the second side member, and the head member form an enclosure configured to receive an open end of an over road trailer positioned proximate the loading dock door opening. In addition to the foregoing features, the enclosure also includes a flexible head curtain removably attached to the head member. The flexible head curtain is configured to hang downwardly from the head member in front of the upper portion of the loading dock door opening and contact an upper surface of the parked trailer.

### BRIEF DESCRIPTION OF THE DRAWINGS

FIG. 1 is a front elevation view of a trailer shelter configured in accordance with an embodiment of the invention.

FIG. 2 is a cross-sectional side elevation view of the truck shelter of FIG. 1.

FIG. 3 is a cross-sectional top view of the truck shelter of FIG. 1.

FIG. 4 is an exploded isometric view of the trailer shelter of FIG. 1.

FIG. 5 is an isometric view showing an over road trailer backed into a trailer shelter configured in accordance with an embodiment of the invention.

### DETAILED DESCRIPTION

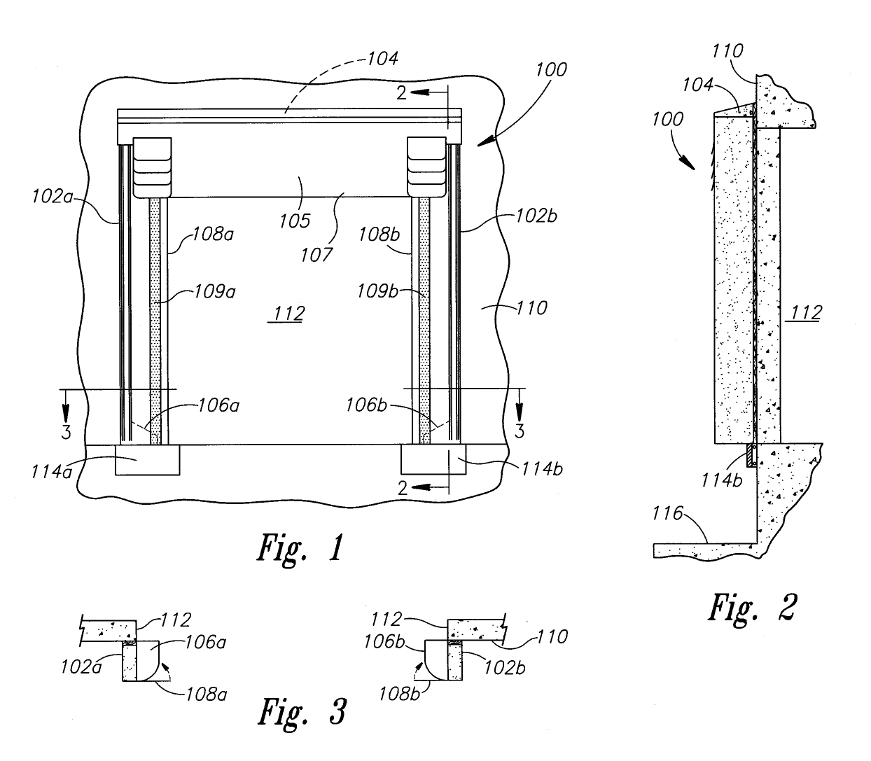

The following disclosure describes various embodiments of trailer enclosures and shelters having durable fabric curtains extending inwardly from impact-resistant side and head members. In one embodiment, for example, a trailer shelter features foam head and side members that seal against the sides and top of a docked trailer. In another embodiment, a foam head member includes a removable head curtain with a plurality of overlapping fabric flaps or pleats that provide wear protection against repeated contact from trailers. Certain details are set forth in the following description and in FIGS. 1-5 to provide a thorough understanding of various embodiments of the invention. Other details describing well-known structures and systems often associated with trailer shelters and enclosures, however, have not been set forth in the following disclosure to avoid unnecessarily obscuring the description of the various embodiments of the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar elements. To facilitate the discussion of any particular element, the most significant digit or digits of any referenced number refer to the Figure in which that element is first introduced. For example, element 110 is first introduced and discussed with reference to FIG. 1.

FIG. 1 is a front elevation view of a trailer shelter 100 configured in accordance with an embodiment of the invention. FIG. 2 is a cross-sectional side view of the trailer shelter 100 taken along line 2-2 in FIG. 1, and FIG. 3 is a cross-sectional top view of the trailer shelter 100 taken along line 3-3 in FIG. 1. Referring to FIGS. 1-3 together, the trailer shelter 100 is positioned around an opening 112 in a warehouse or other building 110. The opening 112 can be at least generally similar to a conventional trailer truck opening having a width of about 10 feet and a height of about 10.5 feet.

The trailer shelter 100 includes a first side member 102a extending vertically along a first side portion of the opening 112, and a second side member 102b extending vertically along a second side portion of the opening 112 opposite to the first side portion. In the illustrated embodiment, each of the side members 102 has a generally rectangular cross-sectional shape with at least approximately equal front and back dimensions of from about 4 inches to about 10 inches, e.g., about 5.5 inches. The side members 102 can also have variable depths and lengths depending upon the particular application. In other embodiments, however, the side members 102 can have other shapes, sizes, and orientations to accommodate particular buildings, door openings, driveway inclinations, etc.

A head member 104 extends horizontally across a top portion of the opening 112 between the first side member 102a and the second side member 102b. As described in greater detail below, the side members 102 and the head member 104 can be manufactured from high density, compressible foam and covered with a vinyl-coated polyester fabric or other suitable material having sufficient strength, durability, manufacturability, cost, and/or other characteristics. One advantage of using foam for the head and side members is it can be impacted by a misaligned trailer and will return to its original shape after the trailer is repositioned without having sustained significant damage.

In one aspect of this embodiment, each of the side members 102 includes a flexible side curtain 108 (identified individually as a first side curtain 108a and a second side curtain 108b) that extends into the opening 112 from the corresponding side member 102. As described in greater detail below, the side curtains 108 are configured to contact the aft end of a trailer (not shown) and flex inwardly toward the building 110 as the trailer backs into the shelter 100. In addition, each of the side curtains 108 can include one or more visual references or guides 109 to help the driver align the trailer as she backs into the shelter 100. In the illustrated embodiment, the visual guides 109 include stripes of reflective and/or brightly colored material positioned where the trailer should contact the side curtains 108. In other embodiments, however, the visual guides can include other forms of visual reference marks.

In another aspect of this embodiment, the shelter 100 further includes a removable top cover 105 installed over the head member 104. The removable cover 105 includes a flexible head curtain 107 that hangs downwardly from the head member 104 in front of an upper portion of the opening 112. Like the side curtains 108, the head curtain 107 is configured to contact the aft end of the trailer and flex inwardly toward the building 110 as the trailer backs into the shelter 100.

In a further aspect of this embodiment, a first removable “draft pad” or close-out pad 106a is removably attached to a lower portion of the first side member 102a, and a second close-out pad 106b is similarly attached to a lower portion of the second side member 102b. The close-out pads 106 extend inwardly toward each other and at least partially close-off and/or seal gaps that may exist between the aft end of the open trailer and the adjacent side member 102 when the trailer is fully installed in the shelter 100.

A first bumper 114a and a second bumper 114b are attached to the building 110 proximate to the lower corners of the opening 112. The bumpers 114 absorb the impact from shipping trailers as they back into the shelter 100. In the illustrated embodiment, the opening 112 can be positioned at a height of from about 46 inches to about 54 inches above a driveway 116. The driveway 116 can have a grade of from about 0% to about ±4%, e.g., about ±1%.

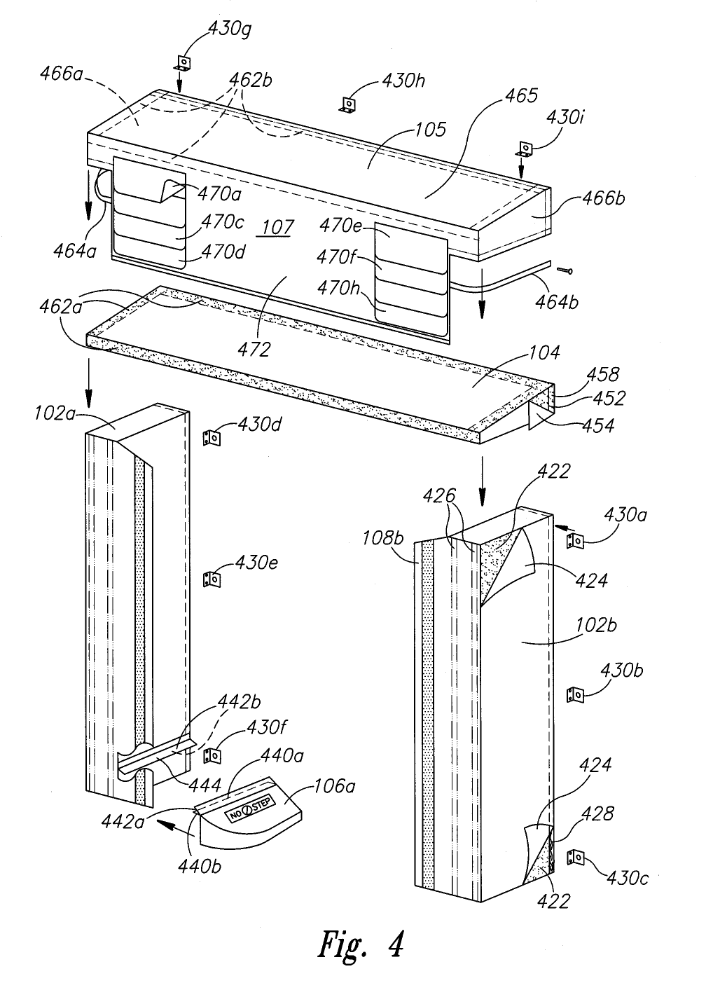

FIG. 4 is an exploded isometric view illustrating various aspects of the trailer shelter 100 in more detail. In one aspect of this embodiment, each of the side members 102 includes a resilient, compressible core material 422 covered by a durable fabric 424. In one embodiment, the compressible core material 422 can include high-density foam (e.g., polyurethane foam) bonded or otherwise attached to an elongate support member 428. The support member 428 can be made from treated wood, galvanized steel, and/or other suitable materials known in the art. In one embodiment, the fabric covering 424 can be made from a hypalon®, polyurethane, or vinyl-coated fabric, such as commercially available vinyl-coated polyester fabric having a weight of from about 12 ounces per square yard to about 40 ounces per square yard, e.g., about 22 ounces per square yard. In other embodiments, the covering 424 can be made from other suitable materials, or it can be omitted if the underlying core material 422 is sufficiently durable by itself.

In the illustrated embodiment, each of the side curtains 108 is fixedly attached to the front surface of the corresponding side member 102 by one or more (e.g., 4) rows of parallel stitching 426. In other embodiments, however, the side curtains 108 can be attached to the side members 102 by other types of permanent and temporary fastening systems including, for example, adhesives, metallic fasteners, removable hook-and-loop systems (e.g., Velcro®), and/or other suitable attachment methods known in the art.

In the illustrated embodiment, the side curtains 108 can be fabricated from two or more plies of impact resistant, resilient fabric having inherent memory. For example, the side curtains 108 can be fabricated from PVC-coated fabric (e.g., PVC-coated polyester fabric, such as 2DSP 5m-5m FH/AD fabric provided by Derco B. V., Schermerweg 33-1821 BE Alkmaar, Holland; www.derco.com, having a weight ranging from about 12 ounces per square yard to about 60 ounces per square yard, e.g., about 40 ounces per square yard). Furthermore, the exterior surface of each of the side curtains 108 can be impregnated with a white guide stripe 109 having a width from about 1 inch to about 6 inches, e.g., about 4 inches. One benefit of using PVC-coated fabric or a similar material for the side curtains 108 is that this material is highly durable and resilient, and has inherent memory that returns the side curtains 108 to a relatively linear orientation when not in use. In the illustrated embodiment, the side curtains 108 are self-reinforced, meaning that the inherent resiliency is provided by monofilaments in the fabric itself, and not by fiberglass stays, batons, and/or other devices that are attached to the fabric material. This method of construction reduces the time and cost associated with manufacturing the side curtains 108. In other embodiments, however, side curtains constructed in accordance with the present disclosure can include various types of stiffening elements and/or materials as required to provide the desired level of resiliency.

The close-out pads 106 can be constructed from high density foam and covered with durable vinyl-coated polyester fabric like the side members 102 described above. In the illustrated embodiment, each of the close-out pads 106 includes a first pad flap 440a and an opposing second pad flap 440b. Each of the pad flaps 440 can include a first attachment feature 442a that releasably engages a second attachment feature 442b positioned on both sides of a side member flap 444. In one embodiment, the first attachment feature can include a “loop” material and the second attachment feature 442b can include a corresponding “hook” material. One such commercially available hook-and-loop material known in the art is Velcro®. In other embodiments, the close-out pads 106 can be releasably attached to the side members 102 using other suitable methods.

The head member 104 includes a resilient and compressible core material 452 bonded or otherwise attached to an elongate support member 458. The core material 452 can include high-density foam (e.g., polyurethane foam), and the support member 458 can include an elongate piece of treated wood. In other embodiments, the support member 458 can be manufactured from galvanized steel or other suitable metallic and non-metallic materials.

In the illustrated embodiment, the head member 104 is angled downwardly or pitched to allow water, snow, and/or other deposits to flow off of the head member 104 during use. More specifically, the head member 104 can have a relatively larger dimension (e.g., from about 5.5 inches to about 9.5 inches, e.g., about 8 inches) at the support member 458, and can taper outwardly from the base to a smaller dimension of from about 2 inches to about 6 inches, e.g., about 4 inches. Due to the resiliency of the compressible material 452, the weight of accumulating snow (water, etc.) will cause the head member 104 to deflect downwardly and automatically shed the snow.

The removable head cover 105 can be releasably attached to the head member 104 by a first attachment feature 462a on the head member 104 which releasably attaches to a second attachment feature 462b on the head cover 105. For example, in the illustrated embodiment the first and second attachment features 462 can include Velcro™. More specifically, the first attachment feature 462a can include a loop material and the second attachment feature 462b can include a corresponding hook material. In other embodiments, other types of releasable fastener systems (e.g., button snaps, metal clips, zippers, etc.) can be used to releasably attach the head cover 105 to the head member 104.

The head cover 105 includes an upper surface 465 and opposing end caps 466 which are shaped and sized to fit snugly over the head member 104. The head curtain 107 hangs downwardly from the forward edge of the head member 104 and drapes over the upper end portion of the opposing side curtains 108. Replaceable elastic retention straps 464 are used to secure the head curtain 107 to the side members 102.

In a further aspect of this embodiment, the head curtain 107 includes a plurality of fabric pleats or flaps 470a-g hingeably attached to a base fabric layer 472. The fabric flaps 470 can be constructed of a durable and resilient material such as, for example, vinyl-coated polyester fabric having a weight of from about 22 ounces to about 60 ounces, e.g., about 40 ounces. As illustrated in FIG. 4, the two groups of overlapping flaps 470 are arranged in shingle-like orientations over the corresponding side curtains 108 so that they will bear the brunt of trailer contact during use. As a result, the flaps 470 protect the removable head cover 105 from damage and reduce the need for repairs or replacement.

The head member 104 and the side members 108 can be fixedly attached to the building 110 (FIGS. 1-3) with a plurality of brackets 430 identified individually as brackets 430a-i. The brackets 430 can be made from various materials having suitable strength, manufacturing, cost, and other characteristics including, for example, metallic materials such as galvanized steel (e.g., 14-gauge galvanized steel). In the illustrated embodiment, the mounting brackets 430 are first fastened to the support members 428 and 458 with one or more fasteners (e.g., screws), and then mounted to the building 110 with concrete anchors and/or other suitable fasteners.

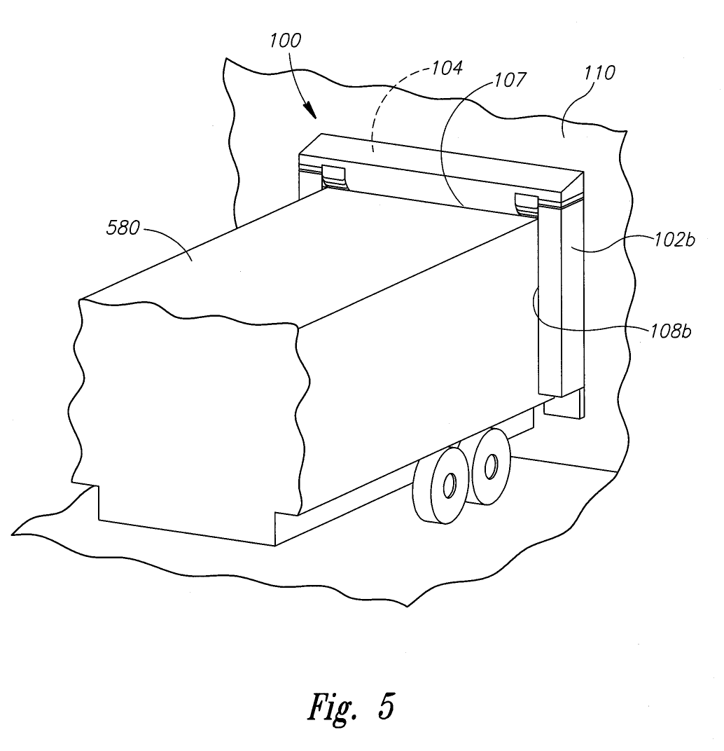

FIG. 5 is an isometric view illustrating a trailer 580 that has been backed into the shelter 100 for loading or unloading goods from or to the building 110. As this view illustrates, the side curtains 108 fold inwardly to seal against the sides of the trailer 580, and the head curtain 107 folds inwardly to seal against the top of the trailer 580. Had the trailer 580 been misaligned and impacted one of the side members 102, the trailer 580 could have been pulled forward and the side member 102 would have returned to its original shape. That way, the trailer can be repositioned and sealed properly. Accordingly, one advantage of the shelter 100 described above is that it is unlikely to sustain significant damage from misaligned trailers.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. An apparatus for forming a shelter over an open end of an over road trailer positioned proximate to an opening in a building, the apparatus comprising:
a flexible head curtain configured to extend horizontally along a top portion of the opening, wherein the flexible head curtain includes at least one fabric flap hingeably attached to an exterior surface of a base fabric layer, wherein the fabric flap is configured to protect the base fabric layer from damage from contact with the over road trailer;
a first side member configured to extend vertically adjacent to a first side portion of the opening;
a second side member configured to extend vertically adjacent to a second side portion of the opening opposite to the first side portion of the opening;
a first self-reinforced fabric side curtain supported by the first side member, wherein the first side curtain is configured to extend vertically in front of the first side portion of the opening; and
a second self-reinforced fabric side curtain supported by the second side member, wherein the second side curtain is configured to extend vertically in front of the second side portion of the opening.

2. The apparatus of claim 1 wherein the flexible head curtain includes a first fabric flap hingeably attached to the exterior surface of the base fabric layer toward a first side portion of the base fabric layer, and a second fabric flap spaced apart from the first fabric flap and hingeably attached to the exterior surface of the base fabric layer toward a second side portion of the base fabric layer, wherein the first and second fabric flaps are configured to protect the base fabric layer from damage from contact with the over road trailer.

3. The apparatus of claim 1 wherein the flexible head curtain includes a plurality of overlaying fabric flaps hingeably attached to the exterior surface of the base fabric layer, wherein the plurality of fabric flaps are configured to protect the base fabric layer from damage from contact with the over road trailer.

4. The apparatus of claim 1 wherein the flexible head curtain includes a first plurality of overlaying fabric flaps hingeably attached to the exterior surface of the base fabric layer toward a first side portion of the base fabric layer, and a second plurality of overlaying fabric flaps spaced apart from the first plurality of fabric flaps and hingeably attached to the exterior surface of the base fabric layer toward a second side portion of the base fabric layer, wherein the first and second pluralities of fabric flaps are configured to protect the base fabric layer from damage from contact with the over road trailer.

5. The apparatus of claim 1 wherein the flexible head curtain includes a plurality of fabric flaps hingeably attached to the exterior surface of the base fabric layer in an overlaying shingle arrangement, and wherein the plurality of fabric flaps is configured to protect the base fabric layer from damage from contact with the over road trailer.

6. The apparatus of claim 1, further comprising a head member configured to extend horizontally along a top portion of the opening between first and second side members, wherein the head member includes a compressible foam portion covered by fabric, and wherein the flexible head curtain is removably attached to the head member.

7. An enclosure for use with a loading dock door opening, the enclosure comprising:
a first side member configured to extend vertically adjacent to a first side portion of the door opening, wherein the first side member includes a first compressible foam portion covered by a first fabric portion;
a second side member configured to extend vertically adjacent to a second side portion of the door opening opposite to the first side portion of the door opening, wherein the second side member includes a second compressible foam portion covered by a second fabric portion;
a head member configured to extend horizontally adjacent to an upper portion of the door opening between the first and second side members, wherein the head member includes a third compressible foam portion covered by a third fabric portion;
a first self-reinforced flexible side curtain supported by the first side member, wherein the first side curtain is configured to extend vertically in front of the first side portion of the door opening;
a second self-reinforced flexible side curtain supported by the second side member, wherein the second side curtain is configured to extend vertically in front of the second side portion of the door opening; and
a flexible head curtain removably attached to the head member, wherein the flexible head curtain is configured to hang downwardly from the head member and extend horizontally in front of the upper portion of the loading dock door opening, whereby the first side member, the second side member, and the head member together form an enclosure configured to receive an open end of an over road trailer positioned proximate the loading dock door opening.

8. The enclosure of claim 7 wherein the flexible head curtain includes at least one fabric flap hingeably attached to an exterior surface of a base fabric layer, wherein the fabric flap is configured to protect the base fabric layer from damage from contact with over road trailers.

9. The enclosure of claim 7 wherein the flexible head curtain includes a first fabric flap hingeably attached to an exterior surface of a base fabric layer toward a first side portion of the base fabric layer, and a second fabric flap spaced apart from the first fabric flap and hingeably attached to the exterior surface of the base fabric layer toward a second side portion of the base fabric layer, wherein the first and second fabric flaps are configured to protect the base fabric layer from damage from contact with over road trailers.

10. The enclosure of claim 7 wherein the flexible head curtain includes a plurality of overlaying fabric flaps hingeably attached to an exterior surface of a base fabric layer, wherein the plurality of fabric flaps are configured to protect the base fabric layer from damage from contact with over road trailers.

11. The enclosure of claim 7 wherein the flexible head curtain includes a first plurality of overlaying fabric flaps hingeably attached to an exterior surface of a base fabric layer toward a first side portion of the base fabric layer, and a second plurality of overlaying fabric flaps spaced apart from the first plurality of fabric flaps and hingeably attached to the exterior surface of the base fabric layer toward a second side portion of the base fabric layer, wherein the first and second pluralities of fabric flaps are configured to protect the base fabric layer from damage from contact with over road trailers.

12. The enclosure of claim 7 wherein the flexible head curtain is removably attached to the head member by a hook and loop fastener system.

13. The enclosure of claim 7 wherein the flexible head curtain extends from a flexible head cover that is removably attached to the head member.

14. The enclosure of claim 7 wherein the flexible head curtain extends from a flexible head cover that is removably attached to the head member by a hook and loop fastener system.

15. The enclosure of claim 7
wherein the first side curtain is comprised of fabric, and
the second side curtain is comprised of fabric.

16. The enclosure of claim 15, further comprising:
a first visual reference mark carried by the first side curtain; and
a second visual reference mark carried by the second side curtain, wherein the first and second visual reference marks are positioned to guide a driver when backing a trailer into the enclosure.

17. The enclosure of claim 7, further comprising:
a first close-out pad releasably attached to a lower portion of the first side member, wherein the first close-out pad includes a fourth compressible foam portion covered by a fourth fabric portion; and
a second close-out pad releasably attached to a lower portion of the second side member, wherein the second close-out pad includes a fifth compressible foam portion covered by a fifth fabric portion, wherein the first close-out pad is configured to extend inwardly from the first side member and at least partially seal a first gap between the over road trailer and the first side member, and wherein the second close-out pad is configured to extend inwardly from the second side member and at least partially seal a second gap between the over road trailer and the second side member.

18. A system for sheltering an open end of an over road trailer positioned adjacent to an opening in a building, the system comprising:
first compressible means for sheltering a first side portion of the opening;
second compressible means for sheltering a second side portion of the door opening opposite to the first side portion of the opening;
third compressible means for sheltering an upper portion of the opening between the first and second side portions;
means for releasably attaching a flexible head curtain to the third compressible means, wherein the flexible head curtain is configured to hang downwardly from the third compressible means and extend horizontally in front of the upper portion of the opening;
first fabric means configured to extend inwardly from the first compressible means and at least partially occlude the opening; and
second fabric means configured to extend inwardly from the second compressible means and at least partially occlude the opening.

19. The system of claim 18, further comprising means for at least reducing damage to the flexible head curtain from contact with the over road trailer.

20. The system of claim 19 wherein the means for at least reducing damage include a plurality of overlaying fabric pleats.
